(19) United States
(12) Patent Application Publication
(10) Pub. No.: US 2001/0038371 A1
(43) Pub. Date: Nov. 8, 2001

(54) Liquid crystal display apparatus

(76) Inventors: Hideki Yoshinaga, Yokohama-shi (JP); Hideo Mori, Yokohama-shi (JP); Yasufumi Asao, Atsugi-shi (JP)

Correspondence Address: FITZPATRICK CELLA HARPER & SCINTO, 30 ROCKEFELLER PLAZA, NEW YORK, NY, 10112, US

(21) Appl. No.: 09/824,046

(22) Filed: Apr. 3, 2001

(30) Foreign Application Priority Data
Apr. 7, 2000 (JP) 106978/2000

(51) Int. Cl. G09G 3/36

(52) U.S. Cl. 345/87

(57) ABSTRACT

A liquid crystal display apparatus is constituted by a liquid crystal device comprising a plurality of scanning electrodes and a plurality of data electrodes arranged in a matrix form, and a liquid crystal to be supplied with a voltage via the scanning electrodes and the data electrodes; first means for selectively transmitting a plurality of color image display data, including red (R), green (G) and blue (B) display data, color by color to the liquid crystal device in a time division manner; a light source unit comprising a plurality of color light source groups each comprising three light sources of red (R), green (G) and the blue (B) corresponding to the colors of the color image display data, said color light source groups being arranged in a plurality of stripe regions parallel to the scanning electrodes so as to allow independent lighting; and second means for controlling a lighting state of the light source unit depending on a display state of the liquid crystal device based on the color image display data. In the liquid crystal device, the liquid crystal has an alignment characteristic such that the liquid crystal is aligned to provide an average molecular axis to be placed in a monostable alignment state under no voltage application, is tilted from the monostable alignment state in one direction when supplied with a voltage of a first polarity at a tilting angle which varies depending on magnitude of the supplied voltage, and is tilted from the monostable alignment state in the other direction when supplied with a voltage of a second polarity opposite to the first polarity at a tilting angle which varies depending on a magnitude of the supplied voltage.

### FIELD OF THE INVENTION AND RELATED ART

The present invention relates to a liquid crystal display apparatus using a liquid crystal device as a light value for use in flat-panel displays, projection displays, etc.

A liquid crystal panel (device) using a nematic liquid crystal or a chiral smectic liquid crystal has been known as a display device for displaying various data.

A twisted nematic (TN) liquid crystal has widely been used conventionally as a material for flat-panel displays as described by M. Schadt and W. Helfrich, “Applied Physics Letters”, Vol. 18, No. 4 (Feb. 15, 1971), pp. 127-128. The TN liquid crystal is used in an active matrix-type liquid crystal device (panel) in combination with switching elements such as thin film transistors (TFTs). The active matrix-type liquid crystal device is free from a problem of cross-talk since each pixel is provided with a switching element and is produced with high productivity with respect to that having a size (diagonal length) of 10-17 in. with quick progress of production technique in recent years.

However, the above-mentioned liquid crystal device using the TN liquid crystal has been accompanied with problems such as a slower response speed and a narrower viewing angle in order to well display clear motion (picture) images.

In order to solve the problems, various alignment modes including an optically compensated bend or birefringence (OCB) mode for improving a response speed, and In-Plane Switching mode and MVA (Multi-domain Vertical Alignment) mode for improving a viewing angle have been developed and proposed.

Further, in order to solve the problems of the conventional TN liquid crystal devices, a liquid crystal device using a chiral smectic liquid crystal exhibiting bistability has been proposed by Clark and Lagerwall (Japanese Laid-Open Application (JP-A) 56-107216, U.S. Pat. No 4,367,924). As the liquid crystal exhibiting bistability, a ferroelectric liquid crystal having chiral smectic C phase (SmC*) or H phase (SmH*) is generally used. Such a ferroelectric liquid crystal provides a very quick response speed because it causes inversion switching of liquid crystal molecules based on their spontaneous polarizations. In addition, the ferroelectric liquid crystal assumes bistable state showing a memory characteristic.

In recent years, an anti-ferroelectric liquid crystal exhibiting tristable state has been proposed by (chandani, Takezoe et al. (“Japanese Journal of Applied Physics”, vol. 27 (1988), pp. L729-). The anti-ferroelectric liquid crystal also provides a very quick response speed similarly as in the ferroelectric liquid crystal.

As another type of the anti-ferroelectric liquid crystal, there has been recently proposed a chiral smectic liquid crystal providing a V-character shaped response characteristic (voltage-transmittance characteristic) which is advantageous for gradational image display and is free from hysteresis (e.g., “Japanese Journal of Applied Physics”, Vol. 36 (1997), pp. 3586-). Further, an active matrix-type liquid crystal device using such a chiral smectic liquid crystal providing the V-shaped voltage-transmittance characteristic has also been proposed (JP-A 9-50049).

As described above in order to provide a liquid crystal display apparatus with a high-speed responsiveness and a good gradational display characteristic, liquid crystal displays of the above-mentioned OCB-mode and anti-ferroelectric liquid crystal materials have been extensively researched and developed more popularly than ever.

Further, with the development of high-speed liquid crystal device, another color liquid crystal device (scheme) has been proposed.

Generally, a conventional color liquid crystal display apparatus (device) comprises a pair of substrates between which color filters of red (R), green (G) and blue (B) and a liquid crystal are disposed and includes a plurality of pixels each comprising a set of color pixels (sub-pixels) of R, G and B which transmittances are independently controllable. Specifically, the transmittances of the color pixels (R, G, B) are controlled for each color pixel at each corresponding portion of the liquid crystal or in combination with a pair of polarizers, thus ordinarily displaying color images according to the additive process of R, G and B. In that case, as a light source, a transmission-type backlight (unit) emitting white light or a reflection-type light source utilizing an external light may be applicable but their display principals of color space are identical to each other.

Such a color liquid crystal display apparatus is, however, accompanied with a lower efficiency of utilizing light. For example, a white color image is displayed based on the additive process of R, G and B by color-mixing ⅓ (as a wavelength region) of Red (red)-light flux, ⅓ of G (green)-light flux, and ⅓ of B (blue)-light flux, on the basis of light fluxes entering the R-color filters spatially occupying ⅓ of all the incident light. Accordingly, an efficiency of light utilization is merely ⅓ before the incident light enters the liquid crystal layer. This means that a larger power consumption is required of the backlight occupying a major part of all the power consumption of the liquid crystal display apparatus.

Further, for each pixel, three color pixels have to be driven independently. As a result, it becomes difficult to effect a pixel design with an increasing definition, thus lowering an opening rate leading to light utilization efficiency. In addition, from the viewpoint of production costs, the above-mentioned color liquid crystal display apparatus is required to use driver ICs and color filters each with larger bits which are constraint factors to the cost of the liquid crystal display apparatus, thus being disadvantageous.

In view of these circumstances, another type of a color liquid crystal display apparatus has been developed extensively. Particularly, a color liquid crystal display apparatus using a backlight-color switching system as described in JP-A 56-27198 has been actively studied. According to the backlight-color switching system, the color of illumination light (backlight) is switched within a time period of at most the flicker frequency and in synchronism therewith, a (light-)transmission state of the liquid crystal panel is controlled to realize color reproduction by using the spatial additive process. The switching system is also called a RGB field sequential display scheme or field sequential color scheme.

However, such a field sequential scheme is accompanied with problems such as lowering in display luminance due to liquid crystal response speed and a poor light utilization efficiency, as described below.

In the field sequential scheme, a light source lighting period in each field period is shorter, thus lowering a resultant display luminance by that much.

Specifically, e.g., when a red image is displayed in a field period according to the field sequential scheme, a liquid crystal panel displays the red image based on an image data in ai red display period (i.e., an image data inputted into the liquid crystal panel in a field period for displaying the red image) but the liquid crystal panel cannot be illuminated with red light until rewriting or the red image is completed. This is because when a light source is turned on during rewriting operation(of a preceding image into a current (red) image) of the liquid crystal panel driven in a hold manner, a display state of the preceding image is kept at a display portion where the rewriting operations not completed, thus failing to obtain a proper gradational red image. This is also the case with blue image and green image. For this reason, in order to effect a desired color display in the field sequential scheme, the light illumination has to be performed after rewriting of image over the entire display panel is completed. As a result, the light source lighting period is decreased to lower a display luminance as a whole.

In order to prevent the lowering in display luminance, image writing operation is performed at high speed to increase the light source lighting period. However, in that case, the light source is turned on in 50% of a field period at the most. Accordingly, there is a limit on remarkable improvement in display luminance.

More specifically, an example of a time chart of data transfer and light source lighting for improving the display luminance is shown in FIG. 11, and a resultant in-plane luminance of a liquid crystal panel is shown in FIG. 12.

As shown in FIG. 11, high-speed transfer and writing of respective color image data may be considered. However, even if a six-fold speed (high-speed) drive compared with an ordinary drive is required for the liquid crystal panel which has already been driven at a three-fold speed based on the ordinary drive speed, a lighting period of at most ½ (2.78 msec) is merely ensured in each field period (5.56 msec).

In the field sequential scheme, a planar luminance of a liquid crystal panel has a distribution (gradient) as shown in FIG. 12, so that a liquid crystal panel with a lot of scanning electrodes causes a difference in luminance between a first scanning pixel and a last scanning pixel, thus resulting in a poor display quality. More specifically, referring to FIG. 12, e.g., in the case where a yellow image is displayed at a maximum luminance, it is possible to avoid a color-mixing display state for each image data level by the above-mentioned driving scheme but an irregularity in in-plane luminance within the liquid crystal panel is caused to occur due to the response speed of a liquid crystal used. In order to reduce a degree of the luminance irregularity, the light source lighting period is further restricted.

In view of this difficulty, a method wherein a liquid crystal panel is divided into several blocks each provided with a set of color light sources of red (R), green (G) and blue (B) and separated each other with a partition plate (sometimes referred to as “light source-division display scheme”) has been proposed in JP-A 5-80716.

According to the light source-division display scheme, a plurality of sets of a R light source, a G light source and a B light source are respectively arranged in parallel with gate lines of a liquid crystal panel to constitute a light source unit. Lighting of each of the color light sources is controlled independently depending on a display state of the liquid crystal panel in each field period, whereby each color light source of the light source unit is turned on in synchronism with writing of a display image in the liquid crystal panel. Accordingly, it is unnecessary to wait writing of each color image data and to effect simultaneous lighting of each color light source in the same field period in the liquid crystal panel area. Further, according to the light source-division display scheme, in each block, the number of scanning electrodes is decreased. As a result, a difference in luminance between a first scanning pixel and a last scanning pixel is reduced.

FIG. 13 shows a time chart for illustrating data transfer timing and light source lighting timing according to the light source-division display scheme, and FIG. 8 shows an in-plane luminance distribution of the liquid crystal panel driven by the light source-division display scheme. In that case, the number of the blocks (the number of light source division) is four and an inputted image data is for a whole-area (100%-)yellow image.

However, even when the liquid crystal panel is driven according to the light source-division display scheme as shown in FIG. 13, it is difficult to prevent a luminance irregularity in the same display plane.

Referring to FIG. 13, at (b) is shown a solid curve representing a transmittance change (response state) in a pixel along the first scanning line in a first block and a broken line representing that along the last scanning line in a first block (a position of ¼ of the entire scanning electrodes in their perpendicular direction). Due to an insufficient response speed of the liquid crystal used, a resultant transmittance is also insufficient. As apparent from the two curves indicated by solid and broken lines, a difference in transmittance between different scanning positions (first line and last line in the first block) is merely a deviation in phase (i.e., the two curves has an identical figure).

However, lighting of light sources is performed at the same time for each divisional region (block), thus causing a luminance irregularity in each divisional lighting region of the light sources as is understood from comparison between curves indicated by solid line (for the first line) and broken line (for the last line) shown at (d) and (e) of FIG. 13.

Referring to FIG. 13, in order to prevent color mixing, a light source extinction (light-off) period is set. However, even if a lighting period is changed in a field period, luminance irregularity cannot be obviated. This is also the case with the liquid crystal panel shown in FIG. 12.

As shown at (c) of FIG. 13, in the light source-division display scheme, light illumination is performed separately in first to four regions. As a result, as shown in FIG. 8, a resultant display state over the entire display area is accompanied with different luminance levels with a boundary line for each light source division blocks of the liquid crystal panel. In such a case, compared with the case where light sources are divided, a luminance level (as an absolute value) in the same display area is decreased but boundary portions are arranged adjacent to each other, thus resulting in display with uncomfortable feeling.

In order to alleviate within the same picture plane in the light source-division display scheme, the liquid crystal response speed per se may be increased. However, even when the liquid crystal shows a very high response speed, the luminance irregularity is not completely obviated.

Another method is one wherein the light source in each light source division region is turned on after the liquid crystal response is completely alleviated, i.e., the transmittance is saturated, with respect to a prescribed gradational image data and turned off before a subsequent writing is started.

According to this method, it is possible to suppress an occurrence of in-plane luminance irregularity but an absolute luminance cannot be obtained, thus losing the significance of the divisional lighting of the light sources.

Another method is one wherein the number of light source division is increased to such an extent that the luminance irregularity is invisible to the viewer. However, this method requires not only a complicated driving operation but also modification of shape of each color light source into one with compact size as in, e.g., an organic EL light source or micro-fabrication to some extent. However, the organic EL light source leaves some problems in terms of production costs, the life of product, etc. Further, in the case where the organic EL light source or a cold cathode tube is used as a light source, it is necessary to provide a partition portion between adjacent light source division blocks (regions) in order to prevent color mixing due to lighting of respective color light sources, thus leaving problems as to the number of light sources and cost. Further, it is difficult to provide a partition portion so as not to be recognized by the viewer, thus lowering a possibility of realization with high display quality.

### SUMMARY OF THE INVENTION

A principal object of the present invention is to provide a liquid crystal display apparatus having solved the above-mentioned problems.

A specific object of the present invention is to provide a liquid crystal display apparatus exhibiting a good color reproducibility and high display efficiency.

According to the present invention, there is provided a liquid crystal display apparatus, comprising:

a liquid crystal device comprising a plurality of scanning electrodes and a plurality of data electrodes arranged in a matrix form, and a liquid crystal to be supplied with a voltage via the scanning electrodes and the data electrodes,

first means for selectively transmitting a plurality of color image display data, including red (R), green (G) and blue (B) display data, color by color to the liquid crystal device in a time division manner,

a light source unit comprising a plurality of color light source groups each comprising three light sources of red (R), green (G) and the blue (B) corresponding to the colors of the color image display data, said color light source groups being arranged in a plurality of stripe regions parallel to the scanning electrodes so as to allow independent lighting, and

second means for controlling a lighting state of the light source unit depending on a display state of the liquid crystal device based on the color image display data,

wherein the liquid crystal has an alignment characteristic such that the liquid crystal is aligned to provide an average molecular axis to be placed in a monostable alignment state under no voltage application, is tilted from the monostable alignment state in one direction when supplied with a voltage of a first polarity at a tilting angle which varies depending on magnitude of the supplied voltage, and is tilted from the monostable alignment state in the other direction when supplied with a voltage of a second polarity opposite to the first polarity at a tilting angle which varies depending on a magnitude of the supplied voltage.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a block diagram of a liquid crystal display apparatus according to the present invention.

FIG. 2 is a circuit diagram of a liquid crystal panel (device) used in the liquid crystal display apparatus of the present invention.

FIGS. 3 and 4 are respectively a view for illustrating a luminance distribution of a light source unit used in the present invention.

FIGS. 5 and 6 are respectively a graph showing a V-T (voltage-transmittance) of a liquid crystal used in the present invention.

FIGS. 7 and 9 are respectively a time chart or illustrating timings of data writing and light source lighting for the liquid crystal display apparatus of the present invention.

FIGS. 8 and 10 are respectively an embodiment of a luminance distribution.

FIGS. 11 and 13 are respectively a time chart for illustrating timings of data writing and light source lighting for a conventional liquid crystal display apparatus.

FIG. 12 is an embodiment of a luminance distribution in a conventional liquid crystal display apparatus.

### DESCRIPTION OF THE PREFERRED EMBODIMENTS

Hereinbelow, the liquid crystal display apparatus of the present invention will be described in detail with reference to FIGS. 1 - 10.

In the above-described field sequential scheme (wherein a sequence of scanning and writing operations is effected to a liquid crystal device) for displaying color images, the light source-division displays scheme described above is effective for utilizing a timewise aperture rate and displaying color image with a good color reproducibility.

In the liquid crystal display apparatus according to the present invention , a light source unit (specifically described later) free from a partition plate as in the above-mentioned light source-division display scheme (using a light source unit including several divisional lighting blocks each separated with a partition plate for allowing clear and uniform display in each divisional lighting block (display region) is used.

FIG. 1 shows a block diagram of an embodiment of a liquid crystal display apparatus according to the present invention principally including a transmission-type liquid crystal device (panel) P and a light source unit B0 for illuminating the liquid crystal device P with a succession of each color light of a plurality of color lights (issued from the light source unit B0).

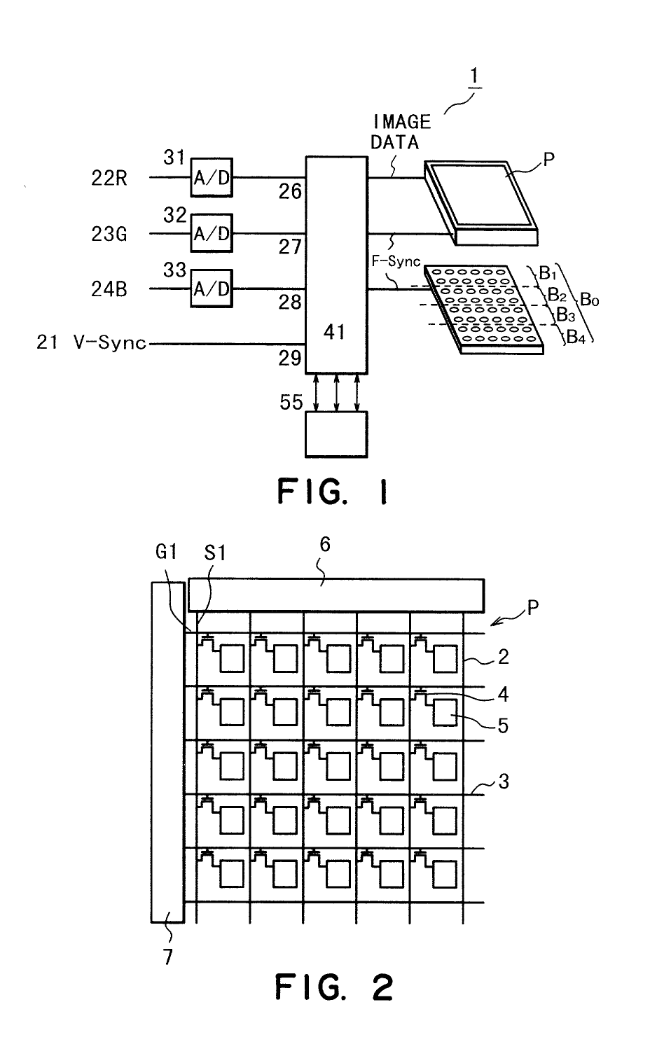

The liquid crystal device P has a structure as shown in FIG. 2. Referring to FIG. 2, the liquid crystal device P at least includes a plurality of scanning electrodes 3 and a plurality of data electrodes 2 arranged in a matrix form and a liquid crystal supplied with a voltage by successively scanning the scanning electrodes 3 through a scanning (gate) line driver 7. Further, the data electrodes 2 are supplied with a data signal through a data (source) line driver 6.

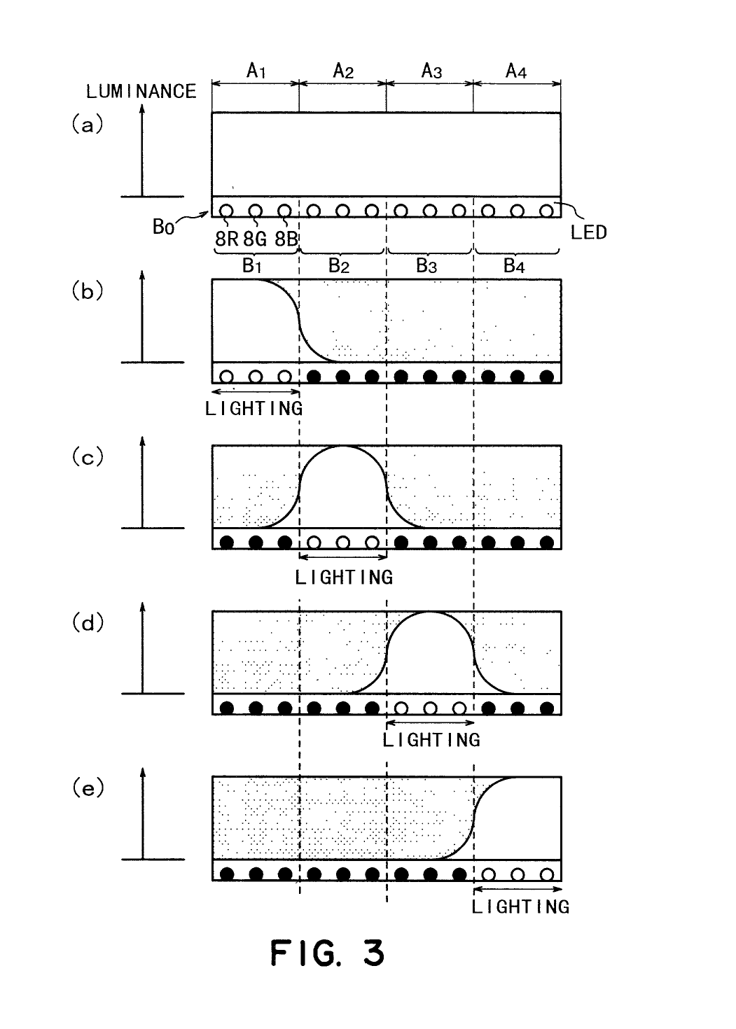

The light source unit B0 includes a plurality of four sets (groups) (B1, B2, B3, B4) each of color light sources of red (R), green (G) and blue (B) disposed in parallel with the scanning electrodes 3. The four sets of color light sources (B1 B2, B3, B4) have light-guide passages leading to stripe regions (A1, A2, A3 an A4, respectively as shown in FIG. 3) arranged in parallel with the scanning electrodes 3. In a preferred embodiment of the present invention, light issued from the light source unit B0 enters the liquid crystal panel P so that a light source illumination range (a range or which light reaches) of any one of the color light source groups (partially) overlaps with that of an adjacent color light source group, thus providing the panel plane of the liquid crystal device P with a substantially uniform luminance when all the color light source groups (B1, B2, B3 an B4) are turned on at the same time.

In this case, each of the color light source groups may be arranged in discrete from along associated scanning electrodes color by color.

More specifically, as shown in FIG. 3, the light source unit B0 comprises a plurality of color light source groups (four groups B1, B2, B3 and B4 in this embodiment) and the stripe regions A1, A2, A3 and A4 of the panel plane are illuminated with light fluxes issued from the color light source groups B1, B2, B3 and B4, respectively (at (b) to (e) of FIG. 3). At that time, between adjacent (two) color light source groups (B1 and B2, B2 and B3, B3 and B4), there is no partition plate as in those described in JP-A 5-80716. As a result, a boundary portion between the adjacent stripe regions (A1 and A2, A2 and A3, A3 and A4) is illuminated with both the color light source group B1 (or B2 or B3) and the color light source group B2 (or B3 or B4). In other words, at the boundary portion (e.g., between A1 and A2), a light source illumination range of the color light source group B1 (shown at (b) of FIG. 3) partially overlaps with a light source illumination range of the color light source group B2 (shown at (c) of FIG. 3).

In this embodiment, as shown at (a) in FIG. 3, each of the color light source groups (e.g., B1) comprises a plurality of color light sources 8R, 8G and 8B (e.g., emitting red (R) light, green (G) light and blue (B) light, respectively, constituting three primary colors). Each of the color light sources 8R, 8G and 8B is arranged in discrete form along (in parallel) with the scanning electrode 3 but may appropriately be arranged in other manners (in terms of the order, direction, number. etc.).

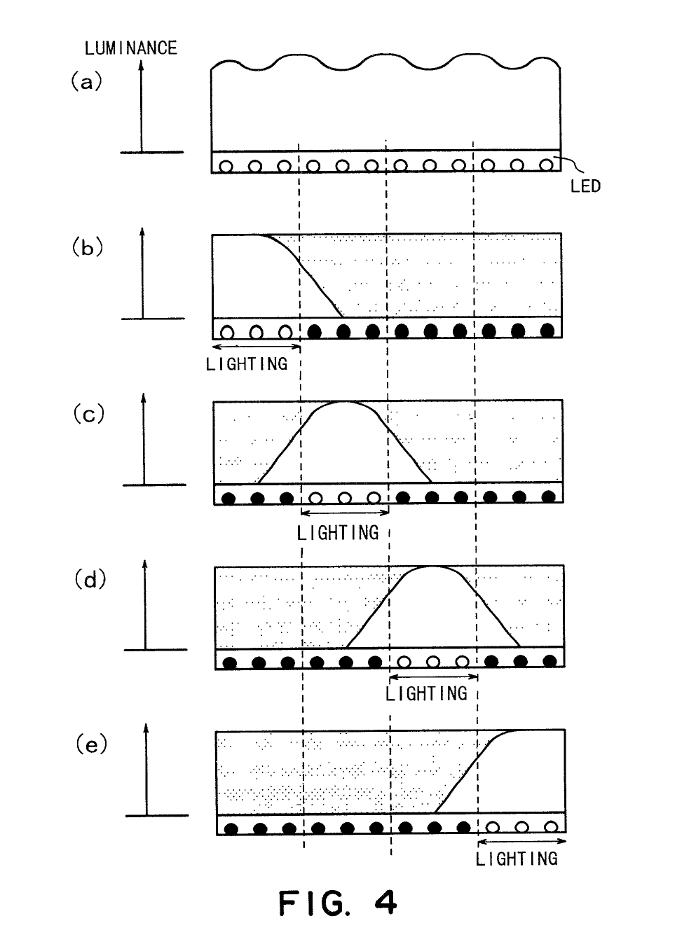

In the present invention, a luminance at a boundary portion between a light source illumination range of a color light source group and an adjacent color light source group may preferably be set to be higher than those at other portions as shown at (a) in FIG. 4.

In the liquid crystal display apparatus using the light source unit B0 allowing divisional (independent) lighting of the plurality of color light source groups B1, B2, B3 and B4, it is necessary to effect display by controlling a timewise opening rate corresponding to a light source illumination range of n-th light source group so as to coincide with that of other light source group.

More specifically, when, e.g., an image data for a red display period is inputted into a 1st (scanning) line of the liquid crystal device in a light source illumination range for n-th light source group, lighting of a red (R) light source of the n-th light source group is initiated before an optical response of liquid crystal responding to the inputted image signal starts. Thereafter, lighting of R (light source) of n+1-th light source group is effected simultaneous with the start of the light source optical response to an inputted red image signal to a 1st scanning line of the liquid crystal device in a light source illumination range for the n+1-th light source group. Similar lighting operation is repeated up to the final light source group of the light source unit, thus completing writing of all the scanning lines of the liquid crystal device (i.e., from the 1st line in the first light source illumination range to the last line in the final light source illumination range of the liquid crystal device).

Thereafter, a reset operation (writing of black image) is successively performed up to the last line of the liquid crystal device in a light source illumination range for n-th light source group to cause reset response of the liquid crystal device. When the optical response of the liquid crystal device is thus completed, the R light source of the n-th light source group is turned off.

Thereafter, a reset operation is effected up to the last line of the liquid crystal device in a light source illumination range for n+1-th group to cause reset response of the liquid crystal device. hen the optical response of the liquid crystal device is thus completed, the R light source of the n+1-th light source group is turned off.

Similar reset operation is repeated up to the final light source group to complete the writing of black image to the final scanning line of the liquid crystal device.

As described above, the plurality of color light source groups constituting the light source unit are turned on so that a lighting period of each light source group covers the complete optical response of the liquid crystal device (from the start of the writing response to the completion of the reset response) in a corresponding light source illumination range. As a result, it becomes possible to prevent a luminance irregularity caused due to a difference in timewise opening rate of the liquid crystal device among the plurality of the light source groups.

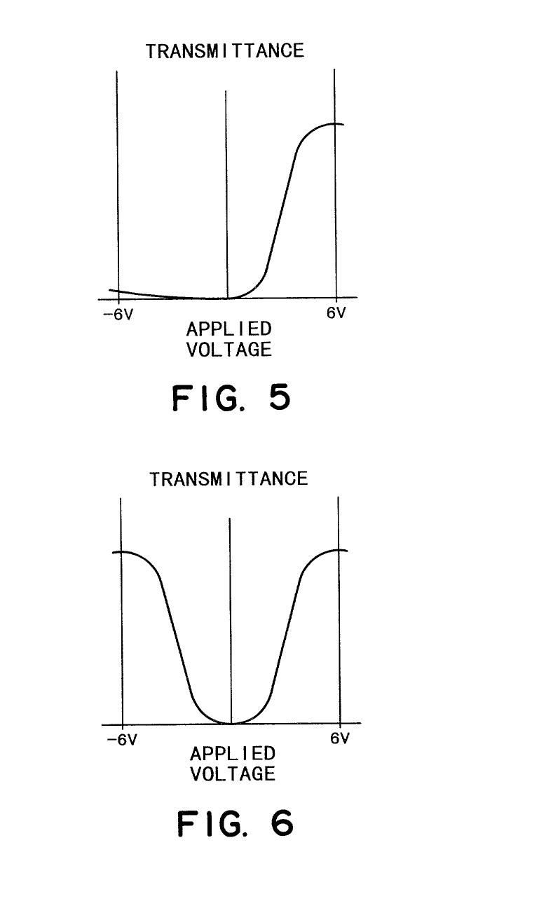

As the liquid crystal used in the liquid crystal display apparatus of the present invention, it is preferred to use a liquid crystal providing a V-T (voltage-transmittance) characteristic as shown in FIG. 5.

More specifically, the liquid crystal material may preferably be placed in an alignment state such that the liquid crystal molecules are aligned to provide an average molecular axis to be mono-stabilized in the absence of an electric field applied thereto and, under application of voltages of one polarity (a first polarity), are tilted in one direction from the average molecular axis under no electric field to provide a tilting angle which varies continuously from the average molecular axis of the monostabilized position depending on the magnitude of the applied voltage. On the other hand, under application of voltages of the other polarity (i.e., a second polarity opposite to the first polarity), the liquid crystal molecules are tilted in the other direction from the average molecular axis under no electric field depending on the magnitude of the applied voltages, thus realizing a halftone (gradation) display. Further, in this embodiment a maximum tilting angle β1 obtained under application of the first polarity voltages based on the monostabilized position is substantially larger than a maximum tilting angle β2 formed under application of the second polarity voltages, i.e., β1>β2,

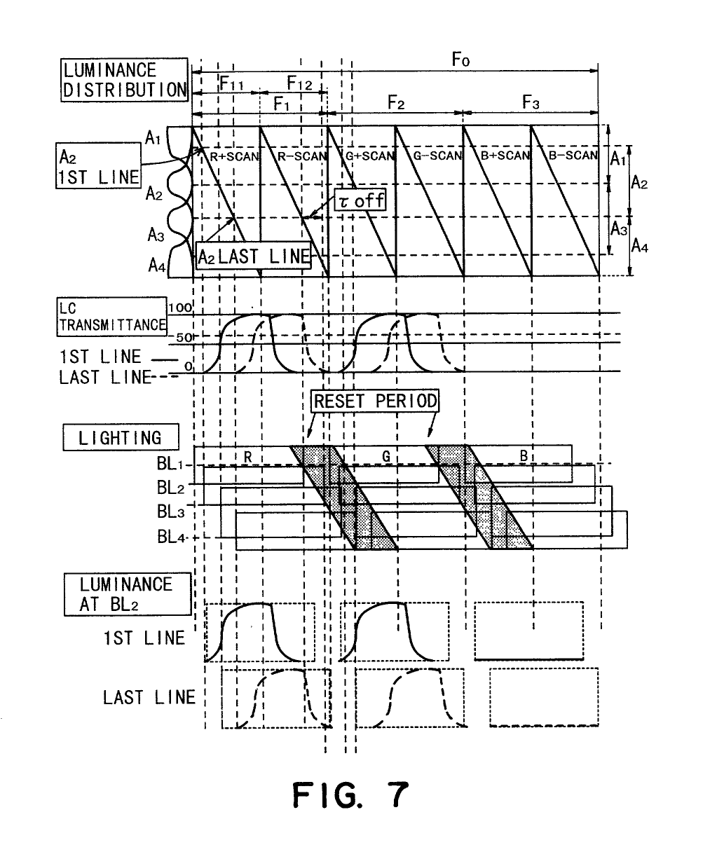

Further, by providing a reset field period for writing a black image at a pixel (i.e., for supplying a voltage for writing the black image to the pixel), it becomes possible to use a liquid crystal providing a V-T characteristic as shown in FIG. 6. In this case, the maximum tilting angles β1 and β2 are substantially identical to each other (β1=β2).

As the light source unit B0 for the liquid crystal display apparatus of the present invention, it is preferred to use a light source unit including a plurality of color light source groups each comprising a set of three color light sources of red (R), green (G) and blue (B) each extending in parallel with scanning electrodes 3 in stripe form and capable of being independently lighted.

In the liquid crystal display apparatus, data electrodes 2 are connected with a time division (sharing) circuit (first means) 41 (as shown in FIG. 1) for selecting color image display data for each color and transmitting the selected color image display data to the data electrodes 2.

As shown in FIG. 7, the time division circuit 41 is adapted to send the selected color image display data to the data electrodes 2 in one (each) frame period F0 divided into three fields F1, F2 and F3 wherein the field F1 is further divided into a writing field F11 for writing (supplying) a voltage for displaying each color image based on a corresponding color image data to an associated pixel and a subsequent reset period F12 for writing (supplying) a voltage for displaying a black image to the pixel.

The light source unit B0 for the liquid crystal display apparatus is connected with a control means (second means) for controlling a lighting state of the light source unit B0 depending on a display state of the liquid crystal device based on the above-mentioned (selected) color image display data.

In a preferred embodiment, as shown in FIG. 7, the liquid crystal device is supplied with the color image display data by the above-mentioned first means 41 in a frame period divided into three field periods, each field period being divided into a writing field for supplying a voltage for display a prescribed color image based on a corresponding color image data to an associated pixel and a subsequent reset period for supplying a voltage for display a black image.

In the liquid crystal display apparatus according to the present invention, one of the color light source groups may preferably be turned on in a field period at a time which is later than a start time for writing a display image in a preceding field period at a pixel along the earliest scanning electrode of pixels of the liquid crystal device in a light source illumination range of the one color light source group and is earlier than that in the field period, and

the one color light source group may preferably be turned off at a time which is later than reset time for resetting the liquid crystal into a black state in the field period at a pixel along the latest scanning electrode of pixels of the liquid crystal device in a light source illumination range of the one color light source group and is earlier than a start time for writing display image in a subsequent field period at a pixel along the earliest scanning electrode of pixels of the liquid crystal device in the light source illumination range of the one color light source group.

In another preferred embodiments, one of the color light source groups is turned on in a field period at a time between a start time for writing a display image at a pixel along the earliest scanning electrode of pixels of the liquid crystal device in a light source illumination range of the one color light source group and a start time for writing a display image at pixels along scanning electrodes on a center line of the light source illumination range of the one color light source group, and

the one color light source group is turned off at a time which is later than reset time for resetting the liquid crystal into a black state in the field period at a pixel along the latest scanning electrode of pixels of the liquid crystal device in a light source illumination range of the one color light source group and is earlier than a start time for writing display image in a subsequent field period at a pixel along the earliest scanning electrode of pixels of the liquid crystal device in the light source illumination range of the one color light source group.

In this case, the light source illumination range of the one color light source group may preferably overlap with a light source illumination range of another light source group, a luminance at an overlapping illumination range being controlled by adjusting the time where the one color light source group is turned on, whereby it becomes possible to effect a substantially uniform display even when the light source unit provides a luminance at the overlapping portion higher than those at other regions as shown at (a) in FIG. 4.

In another preferred embodiment, one of the color light source groups is turned on in a field period at a time which is later than a start time for writing a display image in a preceding field period at a pixel along the earliest scanning electrode of pixels of the liquid crystal device in a light source illumination range of the one color light source group and is earlier than that in the field period, and

the one color light source group is turned off at a time between a start time for writing display image in a subsequent field period at pixels along scanning electrode on a center line of a light source illumination range of the one color light source group, and reset time for resetting the liquid crystal into a black state in the field period at a pixel along the latest scanning electrode of pixels of the liquid crystal device in the light source illumination range of the one color light source group.

In this case, the light source illumination range of the one color light source group may preferably overlap with a light source illumination range of another light source group, a luminance at an overlapping illumination range being controlled by adjusting the time where the one color light source group is turned on, whereby it becomes possible to effect a substantially uniform display even when the light source unit provides a luminance at the overlapping portion higher than those at other regions as shown at (a) in FIG. 4.

In another preferred embodiment, one of the color light source groups is turned on in a field period at a time between a start time for writing a display image at a pixel along the earliest scanning electrode of pixels of the liquid crystal device in a light source illumination range of the one color light source group and a start time for writing a display image at pixels along scanning electrodes on a center line of the light source illumination range of the one color light source group, and

the one color light source group is turned off at a time between a start time for writing display image in a subsequent field period at pixels along scanning electrode on a center line of a light source illumination range of the one color light source group, and reset time for resetting the liquid crystal into a black state in the field period at a pixel along the latest scanning electrode of pixels of the liquid crystal device in the light source illumination range of the one color light source group.

In this case, the light source illumination range of the one color light source group may preferably overlap with a light source illumination range of another light source group, a luminance at an overlapping illumination range being controlled by adjusting the times where the one color light source group is turned on and turned off, whereby it becomes possible to effect a substantially uniform display even when the light source unit provides a luminance at the overlapping portion higher than those at other regions as shown at (a) in FIG. 4.

In another preferred embodiment, the light source unit B0 provides a luminance which is controlled by adjusting a voltage supplied to the plurality of color light source groups. Further, the light source unit B0 may preferably provide a luminance which is controlled by adjusting a current passing through the plurality of color light source groups. Further, the light source unit B0 may preferably provide a luminance which is controlled by adjusting a pulse period of a voltage supplied to or a current passing through the plurality of color light source groups. In these cases, the pulse period may preferably be sufficiently shorter than a lighting period of the color light source groups B1, B2, B3 and B4.

In another preferred embodiment, the plurality of color light source groups B1, B2, B3 and B4 are divided into a plurality of blocks arranged in parallel with the scanning electrodes 3, and the light source unit B0 is provided with light-guide passages for guiding light from the divided color light source groups to corresponding divided regions of a panel plane of the liquid crystal device arranged in parallel with the scanning electrodes. At that time, light from one of the divided color light source group may preferably provides a light source illumination range which overlaps with at most two light source illumination ranges given by other color liquid crystal groups.

In another preferred embodiment, one of the color light source groups is turned on in a field period at a time between a start time for writing a display image at a pixel along the earliest scanning electrode of pixels of the liquid crystal device in a light source illumination range of the one color light source group and a start time for writing a display image at pixels along scanning electrodes on a center line of the light source illumination range of the one color light source group, and

the one color light source group is turned off at a prescribed time between a start time for writing display image in a subsequent field period at pixels along scanning electrode on a center line of a light source illumination range of the one color light source group, and reset time for resetting the liquid crystal into a black state in the field period at a pixel along the latest scanning electrode of pixels of the liquid crystal device in the light source illumination range of the one color light source group. In this case, prescribed time may preferably be changed depending on a change in response characteristic of the liquid crystal device in an operation temperature range.

As described above, according to the above-mentioned embodiments of the liquid crystal display apparatus of the present invention, it is possible to reduce a luminance irregularity over the pane plane of the liquid crystal device, thus providing good display qualities free from uncomfortable feeling.

Further, the liquid crystal display apparatus is driven in a simple manner and advantageous in terms of production cost and the life of product.

Hereinbelow, the present invention will be described based on more specific embodiments with reference to the drawings.

### First Specific Embodiment

In this embodiment, a liquid crystal display apparatus 1 comprises a liquid crystal device (panel) P and a light source unit B0 (LED light source unit) as shown in FIG. 1.

The liquid crystal device P has an active matrix cell structure as shown in FIG. 2.

Referring to FIG. 2, the active matrix cell structure comprises a plurality of scanning signal lines 3 (gate lines G1) and a plurality of data signal liens 2 (source lines S1) arranged in a matrix form including a plurality of pixels each at an intersection thereof. Each pixel is provided with a TFT (thin film transistor) 4 and a pixel electrode 5 defining the pixel.

Each of the TFTs 4 has a source electrode supplied with a data signal voltage (source voltage) for providing display data from a data signal line drive circuit 6 via the data signal lines 2 and has a gate electrode supplied with a scanning signal voltage (gate voltage) for determining scanning timing from a scanning signal line drive circuit 7 via the scanning signal lines 3.

The liquid crystal used in this embodiment comprises a (threshold-less) ferroelectric liquid crystal providing a V-T (voltage-transmittance) characteristic as shown in FIG. 5 wherein the V-T curve assumes a V character (referred to as “Half-V character-shaped V-T characteristic”). Referring to FIG. 5, the liquid crystal providing Half-V character-shaped V-T characteristic shows a transmittance which continuously changes depending on an applied voltage on both the positive-polarity side and the negative polarity side. Further, the transmittance change is free from a clear threshold value.

FIG. 1 is a block diagram of the liquid crystal apparatus wherein based on inputted color image signals, lighting of the light source unit B0 is performed in synchronism with writing of the signals to the liquid crystal device P while dividing the light source unit B0 into four light source groups (blocks) B1, B2, B3 and B4, whereby it becomes possible to effect full-color display with a good color reproducibility and high efficiency.

Referring to FIG. 1, a synchronizing signal V-Sync is inputted from an input terminal 21 and component video signals including a red (R) signal, a green (G) signal and a blue (B) signal are inputted from an input terminal 22 for R signal, an input terminal 23 for G signal and an input terminal 24 for B signal, respectively, and are subjected to digital conversion by A/D converters 31, 32 and 33, respectively.

The RGB digital signals outputted from the A/D converters 31, 32 and 33 are inputted in parallel form into input terminals 26, 27 and 28 and then are outputted in serial form via a memory 55. In this embodiment, the liquid crystal used provides th V-T characteristic as shown in FIG. 5, so that respective signals (for sub-field periods R(+)/R(−)/G(+)/G(−)/B(+)/B(−) are subjected to time-division multiplexing to be supplied as six-fold speed signals to a monochromatic (color filter-less) liquid crystal display device P. Further, the synchronizing signal V-Sync supplied from the input terminal 29 is formed in synchronizing signals F-Sync, which are separated synchronously and supplied to the color filter-less liquid crystal display device P and the light source unit 45, respectively.

In the color filter-less liquid crystal device P shown in FIG. 1, the inputted or six-fold speed digital signals are converted into analog signals by driver ICs (not shown) of the display device P, thus displaying monochromatic images based on timing of the synchronizing signal F-Sync. Specifically, in divided six sub-field periods R(+)(=F11)/R(−)(=F12)/G(+)/G(−)/B(+)/B(−) in one frame period F0, respective images for respective field periods are sequentially displayed.

In the light source unit B0 divided into four color light source groups (display blocks) B1, B2, B3 and B4, light source control signals for respective colors in respective display blocks are formed based on the inputted synchronizing signal F-Sync and based on timing of the thus-formed light source control signals, lighting of three primary color-light source is performed by shifting a phase or each display block.

FIG. 3 shows a view for illustrating a luminance and illumination range given by lighting of each one color-light source group (B1 at (b), B2 at (c), B3 at (d) and B4 at (e)) of the LED light source unit B0.

As shown in FIG. 3, the LED light source unit B0 is arranged so that the plurality of color light source groups B1 to B4 are divided into a plurality of blocks arranged in parallel with the scanning electrodes, and the light source unit is provided with light-guide passages for guiding light from the divided color light source groups to corresponding divided regions of a panel plane of the liquid crystal device arranged in parallel with the scanning electrodes, light from one of the divided color light source group providing a light source illumination range which overlaps with a light source illumination range given by an adjacent divided color liquid crystal group. As a result, the LED light source unit B0 provides a substantially uniform luminance over the panel plane of the liquid crystal device P when all the plurality of color light source groups are turned on at the same time.

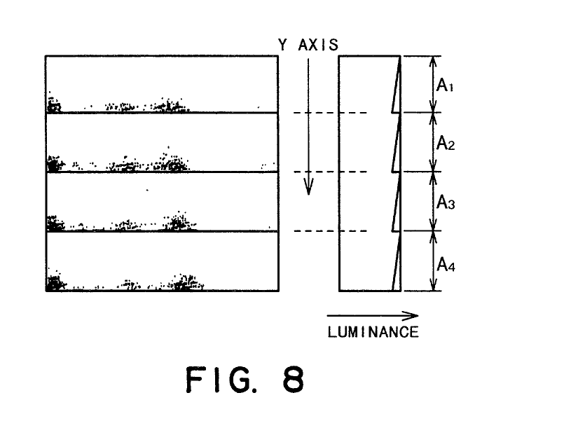

FIG. 7 shows a time chart for illustrating timings of data transfer (image writing) and lighting of the color light source groups B1 to B4 of LED light source unit B0. As a result, as specifically described hereinbelow, a difference in luminance level for each light source group (block) can effectively be obviated, thus resulting in a desired luminance distribution free from boundary lines shown in FIG. 8.

Referring to FIG. 1, one frame period F0 (=16.67 msec) is divided into three field periods F1, F2 and F3 which are further divided into six sub-field periods (i.e., F11 (R(+)) (=2.78 msec) and F12 (R(−)) for the first field period F1, G(+) and G(−) for the second field period, and B(+) and B(−) for the third field period).

In this embodiment, as shown in FIG. 7, the divided four color light source groups B1 to B4 are required to be independently lighted. Further, it is important that the respective lighting operations of the color light source groups B1 to B4 is controlled depending on timings of optical response of the liquid crystal in the liquid crystal device in respective light source illumination ranges for the light source groups, respectively.

The writing operation to the liquid crystal device is performed according to a raster (sequential) scanning scheme (as shown in FIG. 7). Specifically, based on timing of the synchronizing signal V-Sync, the panel plane (picture area) of the liquid crystal device is successively scanned (for writing) from the upper (first) region A1 to the lower (fourth) region A4 (via the second and third regions A2 and A3) in a prescribed period (e.g., F11 (=2.83 msec)).

In this embodiment, the scanning period (corresponding to a light source illumination range for each color light source group) of the liquid crystal device is dependent on a light source illumination range of one of the divided color light source groups since the divided color light source groups are independently controlled. In other words, the scanning period is determined by the number of scanning electrodes (lines) illuminated with light issued from an associated color light source group.

FIG. 7 also shows an optical response characteristic (a transmittance change) of the liquid crystal device in the case where 100%-yellow display is effected, wherein a solid-line curve represents a behavior of the optical response with respect to the earliest writing (scanning) line (the first line) in a light source illumination range of the second color light source group B2 and a broken-line curve represents that with respect to the latest (last) writing line in the light source illumination range of the second color light source group B2.

As shown in FIG. 7, the optical response of the liquid crystal requires a rising time (response start time) τon of 2 msec and a reset time (response termination time) τoff of 0.9 msec. At the time of start of writing in the 1st line in the illumination range for the second light source group, lighting of the second light source group is performed so as to provide a desired lighting luminance. Further, after at least a lapse of the reset (writing termination) time doff after completion of reset writing to the last line in the illumination range of the second light source group, the second light source group is turned off.

As a result, all the region (e.g., the second region A2) to be illuminated by one color light source group (e.g., the second light source group B2) of the light source unit in a period from the start of display writing and the termination (completion) of reset writing is illuminated with light issued from the one (second) color light source group, whereby it is possible to obviate a luminance irregularity due to a difference in opening rate corresponding to the light source illumination range of one of the divided light source groups at the panel plane of the liquid crystal device.

According to the above-mentioned lighting scheme, even when a clear boundary between adjacent display blocks (illuminated regions) is not present, it is possible to suppress the luminance irregularity given by adjacent color light source groups, depending on the corresponding opening rate of the liquid crystal device, thus allowing display with a high efficiency of light utilization and a high luminance free from uncomfortable feeling in the field sequential driving scheme.

In this embodiment, it is possible to use as the light source unit a cold cathode tube-type light source unit or an organic EL-type light source unit in place of the LED-type light source unit.

Further, as the liquid crystal, it is possible to use a liquid crystal providing a V-T characteristic as shown in FIG. 6 in place of the liquid crystal providing Half-V character-shaped V-T characteristic (FIG. 5).

### Second Specific Embodiment

In this embodiment, a liquid crystal display apparatus includes a liquid crystal device (panel) P using a liquid crystal providing the Half-V character-shaped V-T characteristic similarly as in First Specific Embodiment.

In this embodiment, a light source unit B0 is modified so as to provide a luminance characteristic as shown in FIGS. 4, 9 and 10 in order to minimize a luminance irregularity at a panel plane of the liquid crystal device.

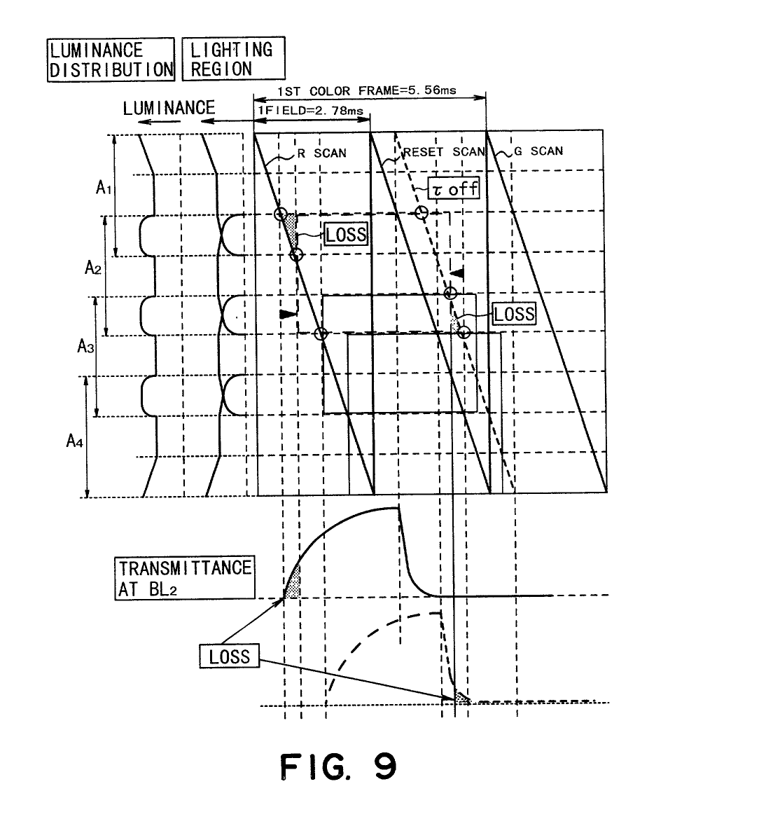

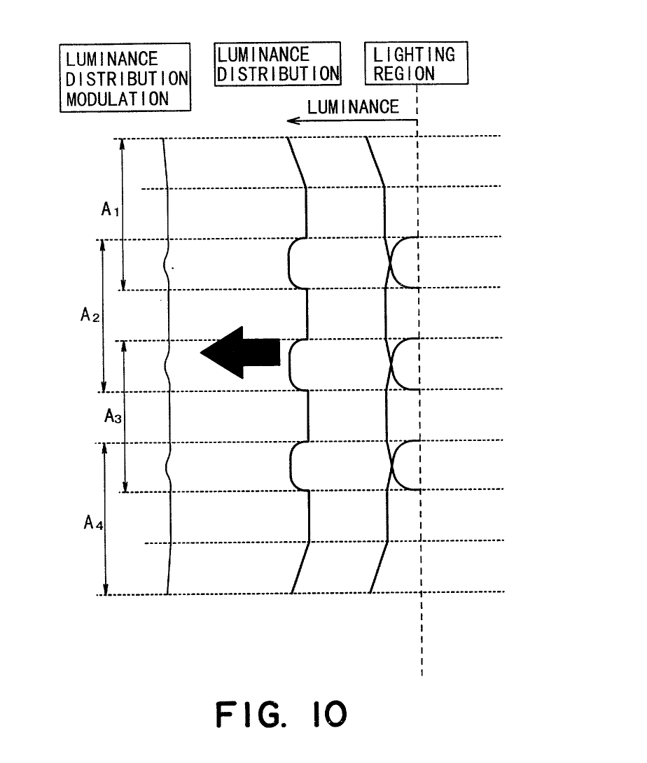

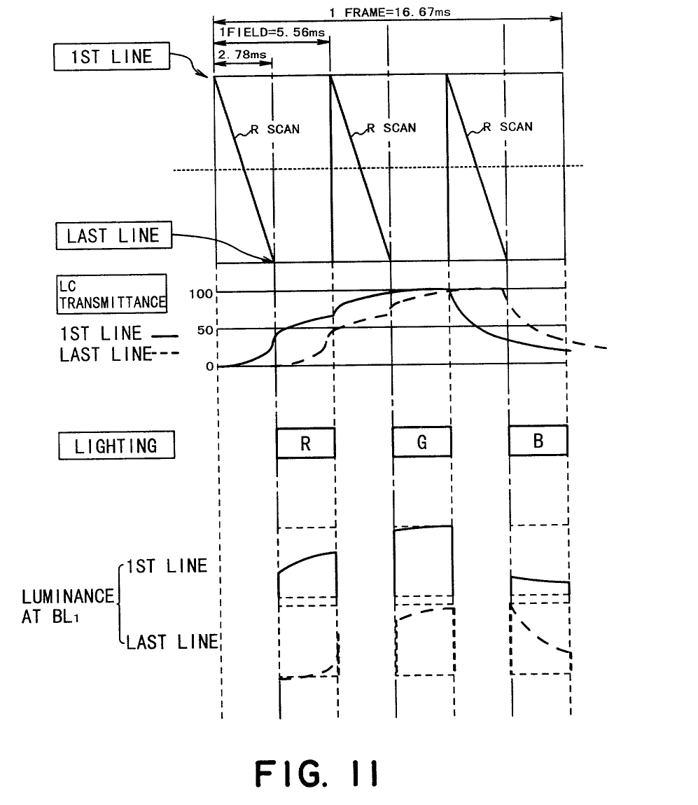

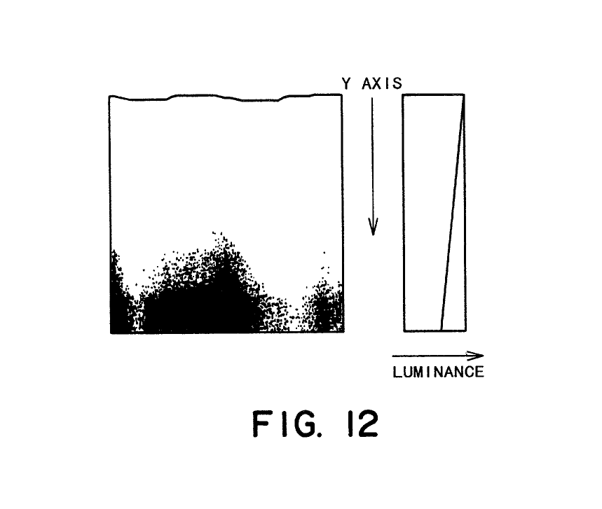

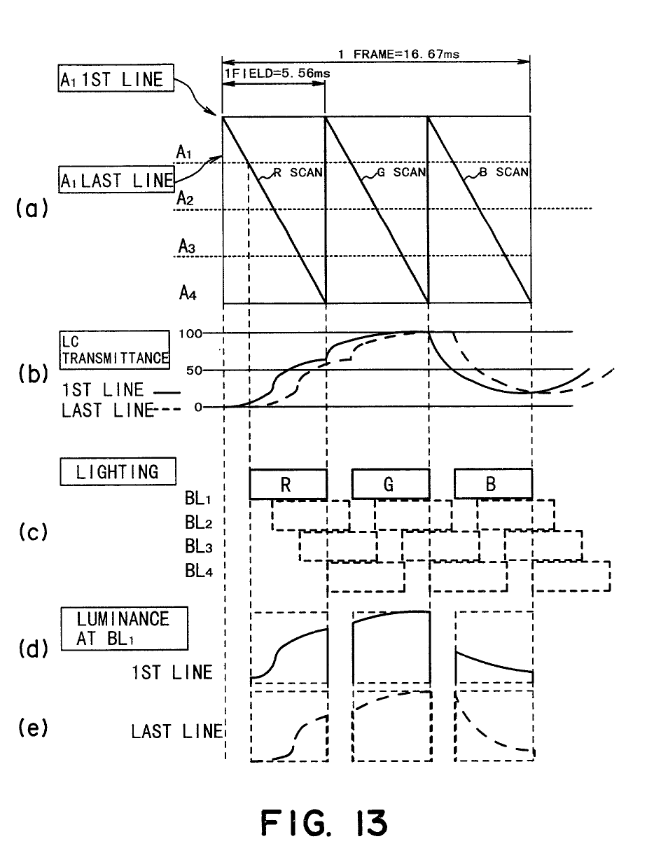

FIG. 9 shows a time chart for illustrating timings of data transfer (image writing) and lighting of the light source unit, and FIG. 10 shows a luminance distribution given by the lighting of the light source unit.

In this embodiment, the light source unit is divided into four color light source groups capable of being lighted (driven) independently, similarly as in First Specific Embodiment. Similarly, the image writing is performed based on timing of a synchronizing signal V-Sync in the sequential (raster) scanning scheme, wherein writing into pixels (scanning of scanning electrodes) is performed from an upper side to a lower side of the panel place of the liquid crystal device in ai period of 2.78 msec.

The light source unit B0 used in this embodiment is divided into four color light source groups B1, B2, B3 and B4 as shown in FIG. 4.

Each light source group requires a period (time duration) of 0.93 msec for writing to a corresponding illuminated region and an overlapping period of 0.309 msec where adjacent (two) light source groups provided an overlapping light source illumination range as shown in FIG. 9.

FIG. 9 also shows a response characteristic (a transmittance change) of the liquid crystal device when 100%-yellow display is effected in a R (red) field period and a G (green) field period.

Each of rectangular regions enclosed by broken (or solid) lines in FIG. 9 represents a lighting period and a lighting timing of each color-light source group.

Referring to FIG. 9, for lighting operation of the light source unit, a red (R) light source of the first color-light source group is turned on in a corresponding light source illumination range (first region A1) with a lapse of a period (=0.309 msec), required for writing red (R)-field data over an overlapping portion of adjacent light source illumination ranges (display regions), from a time where the earliest R-field data is written in the corresponding light source illumination range. In other words, at the time, on a panel plane of the liquid crystal device, in the first region A1 in which the light source response is started earliest in a plurality of regions A1 to A4, there is a loss of light for a lighting period of 0.309 msec. Similarly, also in a display region wherein the data writing is performed earlier than a time where a corresponding light source is turned on, there is a loss of light corresponding to a difference in time (duration) between the start of writing and the start of lighting.

Thereafter, a red (R) light source of the second color-light source group is turned on with a lapse of a period (0.309 msec), required for writing red (R)-field data over an overlapping region of the first and second display regions A1 and A2, from a time where the earliest R-field data is written in the second display region A2. Similarly, lighting operations for red (R) light sources of the third and fourth color-light source groups are performed, respectively (with a lapse of 0.309 msec from the start of the earliest corresponding R-field data in the regions A3 and A4, respectively).

Thereafter, reset scanning (writing) is started in the first display range A1 in the R field period and then a red (R) light source is turned off at a time earlier by 0.309 msec (required for reset-writing the reset data over an overlapping portion of adjacent light source illumination ranges (display regions) than a time after a lapse of reset period τoff (required for resetting the liquid crystal in a reset (black) state) from the time of writing of the latest reset data. In other words, in the first display region A1, given by the first color-light source groups, wherein the latest reset data writing is effected, a loss of light corresponding to earlier termination of lighting for 0.309 msec than the completion of the liquid crystal response is caused to occur.

Further, when the R light source is turned off at a time after a lapse of 0.309 msec (required for data writing over an overlapping portion of adjacent light source illumination ranges) from a time which is later than the time of reset at a writing by a period doff (required for resetting the liquid crystal in a reset state), the light loss is caused to occur also in a region where the reset response of liquid crystal is not completed.

Thereafter, reset scanning (writing) is started in the first display region A2 in the R field period and then a red (R) light source of the second color-light source group is turned off at a time earlier by 0.309 msec (required for reset-writing the reset data over an overlapping portion of adjacent light source illumination ranges (display regions) than a time after a lapse of reset period τoff (required for resetting the liquid crystal in a reset (black) state) from the time of writing of the latest reset data.

Similarly, the above reset operation for R light source is successively performed i such a manner that a red (R) light source of the third (or fourth) color-light source group is turned off at a time earlier by 0.309 msec (required for reset-writing the reset data over an overlapping portion of adjacent light source illumination ranges (display regions) than a time after a lapse of reset period τoff (required for resetting the liquid crystal in a reset (black) state) from the time of writing of the latest reset data.

Further, similarly as in the R field period, the above reset operation is repeated in a green (G) field period and in a blue (B) field period (not shown).

A resultant luminance in this specific embodiment is schematically shown in FIG. 4.

As shown in FIG. 4, a luminance at an overlapping portion illuminated with light fluxes issued from adjacent color light source groups (ordinary providing a higher luminance) is effectively lowered by control of lighting timings of the light source unit.

According to this specific embodiment, in each illumination range for each color-light source group, a lighting period of a corresponding color-light source group for a driving operation of the liquid crystal device from the start of optical response to the display data writing to the termination of reset response to the reset data writing is effectively shortened, thus allowing a stepwise decrease in luminance of each color-light source group from a luminance at a center portion of an illumination range of the color-light source group. As a result, it is possible to effect a compensation drive of the light source unit such that a luminance at an overlapping illumination range (given by adjacent color-light source groups) liable to be generally increased is effectively suppressed.

In this embodiment, the lighting period of each color-light source group is shortened with respect to both the start time for the start of the liquid crystal response and the termination of the reset response but may be shortened with respect to either one of its lighting start time or its lighting termination time.

Further, the lighting period of each color-light source unit may appropriately be controlled depending on a luminance irregularity (caused by the light source unit) on the panel plane of the liquid crystal device, thus further enhancing display qualities.

In the present invention, the control of display luminance by adjusting the lighting period of each color-light source group largely depends upon a change in response speed of liquid crystal used, so that, particularly when the light source unit is driven so as to correct a luminance irregularity of the light source unit, the lighting period (timing) control of the respective color-light source groups may preferably be performed such that the above-mentioned compensation drive of the light source unit for suppression the light source luminance irregularity is performed in combination with a temperature compensation based on an operational environment of the liquid crystal device used.

The lighting period (timing) control for providing a uniform in-plane luminance may also be realized by correcting (adjusting) an amount of a voltage or a current supplied to the color-light source groups, respectively.

Further, it is possible to effect the lighting period control by using a pulse modulation scheme for controlling a lighting period while retaining the voltage or current supplied to each light source group, thus uniformizing a light source luminance level.

As described hereinabove, according to the present invention, it is possible to effectively reducing a luminance irregularity, thus providing good display qualities free from uncomfortable feelings.

Further, it becomes possible to provide a liquid crystal display apparatus having advantages in terms of driving scheme, production costs, the life of product, etc.

What is claimed is:

1. A liquid crystal display apparatus, comprising:
a liquid crystal device comprising a plurality of scanning electrodes and a plurality of data electrodes arranged in a matrix form, and a liquid crystal to be supplied with a voltage via the scanning electrodes and the data electrodes,
first means for selectively transmitting a plurality of color image display data, including red (R), green (G) and blue (B) display data, color by color to the liquid crystal device in a time division manner,
a light source unit comprising a plurality of color light source groups each comprising three light sources of red (R), green (G) and the blue (B) corresponding to the colors of the color image display data, said color light source groups being arranged in a plurality of stripe regions parallel to the scanning electrodes so as to allow independent lighting, and
second means for controlling a lighting state of the light source unit depending on a display state of the liquid crystal device based on the color image display data,
wherein the liquid crystal has an alignment characteristic such that the liquid crystal is aligned to provide an average molecular axis to be placed in a monostable alignment state under no voltage application, is tilted from the monostable alignment state in one direction when supplied with a voltage of a first polarity at a tilting angle which varies depending on magnitude of the supplied voltage, and is tilted from the monostable alignment state in the other direction when supplied with a voltage of a second polarity opposite to the first polarity at a tilting angle which varies depending on a magnitude of the supplied voltage.

2. An apparatus according to claim 1, wherein the liquid crystal device is supplied with the color image display data by the first means in a frame period divided into three field periods, each field period being divided into a writing field for supplying a voltage for display a prescribed color image based on a corresponding color image data to an associated pixel and a subsequent reset period for supplying a voltage for display a black image.

3. An apparatus according to claim 3, wherein the plurality of color light source groups are divided into a plurality of blocks arranged in parallel with the scanning electrodes, and the light source unit is provided with light-guide passages for guiding light from the divided color light source groups to corresponding divided regions of a panel plane of the liquid crystal device arranged in parallel with the scanning electrodes, light from one of the divided color light source groups providing a light source illumination range which overlaps with a light source illumination range given by an adjacent divided color liquid crystal group.

4. An apparatus according to claim 1, wherein the light source unit provides a substantially uniform luminance over the panel plane of the liquid crystal device when all the plurality of color light source groups are turned on at the same time.

5. An apparatus according to claim 1, wherein the light source unit includes a plurality of color light source groups each providing a light source illumination range, adjacent light source illumination ranges having an overlapping portion where the light source unit provides a luminance higher than a luminance at other portions.

6. An apparatus according to claim 2, wherein one of the color light source groups is turned on in a field period at a time which is later than a start time for writing a display image in a preceding field period at a pixel along the earliest scanning electrode of pixels of the liquid crystal device in a light source illumination range of said one color light source group and is earlier than that in the field period, and
said one color light source group is turned off at a time which is later than reset time for resetting the liquid crystal into a black state in the field period at a pixel along the latest scanning electrode of pixels of the liquid crystal device in a light source illumination range of said one color light source group and is earlier than a start time for writing display image in a subsequent field period at a pixel along the earliest scanning electrode of pixels of the liquid crystal device in the light source illumination range of said one color light source group.

7. An apparatus according to claim 3, wherein one of the color light source groups is turned on in a field period at a time which is later than a start time for writing a display image in a preceding field period at a pixel along the earliest scanning electrode of pixels of the liquid crystal device in a light source illumination range of said one color light source group and is earlier than that in the field period, and
said one color light source group is turned off at a time which is later than reset time for resetting the liquid crystal into a black state in the field period at a pixel along the latest scanning electrode of pixels of the liquid crystal device in a light source illumination range of said one color light source group and is earlier than a start time for writing display image in a subsequent field period at a pixel along the earliest scanning electrode of pixels of the liquid crystal device in the light source illumination range of said one color light source group.

8. An apparatus according to claim 2, wherein one of the color light source groups is turned on in a field period at a time between a start time for writing a display image at a pixel along the earliest scanning electrode of pixels of the liquid crystal device in a light source illumination range of said one color light source group and a start time for writing a display image at pixels along scanning electrodes on a center line of the light source illumination range of said one color light source group, and
said one color light source group is turned off at a time which is later than reset time for resetting the liquid crystal into a black state in the field period at a pixel along the latest scanning electrode of pixels of the liquid crystal device in a light source illumination range of said one color light source group and is earlier than a start time for writing display image in a subsequent field period at a pixel along the earliest scanning electrode of pixels of the liquid crystal device in the light source illumination range of said one color light source group.

9. An apparatus according to claim 3, wherein one of the color light source groups is turned on in a field period at a time between a start time for writing a display image at a pixel along the earliest scanning electrode of pixels of the liquid crystal device in a light source illumination range of said one color light source group and a start time for writing a display image at pixels along scanning electrodes on a center line of the light source illumination range of said one color light source group, and
said one color light source group is turned off at a time which is later than reset time for resetting the liquid crystal into a black state in the field period at a pixel along the latest scanning electrode of pixels of the liquid crystal device in a light source illumination range of said one color light source group and is earlier than a start time for writing display image in a subsequent field period at a pixel along the earliest scanning electrode of pixels of the liquid crystal device in the light source illumination range of said one color light source group.

10. An apparatus according to claim 5, wherein one of the color light source groups is turned on in a field period at a time between a start time for writing a display image at a pixel along the earliest scanning electrode of pixels of the liquid crystal device in a light source illumination range of said one color light source group and a start time for writing a display image at pixels along scanning electrodes on a center line of the light source illumination range of said one color light source group, and
said one color light source group is turned off at a time which is later than reset time for resetting the liquid crystal into a black state in the field period at a pixel along the latest scanning electrode of pixels of the liquid crystal device in a light source illumination range of said one color light source group and is earlier than a start time for writing display image in a subsequent field period at a pixel along the earliest scanning electrode of pixels of the liquid crystal device in the light source illumination range of said one color light source group.

11. An apparatus according to claim 8, wherein the light source illumination range of said one color light source group overlaps with a light source illumination range of another light source group, a luminance at an overlapping illumination range being controlled by adjusting the time where said one color light source group is turned on.

12. An apparatus according to claim 2, wherein one of the color light source groups is turned on in a field period at a time which is later than a start time for writing a display image in a preceding field period at a pixel along the earliest scanning electrode of pixels of the liquid crystal device in a light source illumination range of said one color light source group and is earlier than that in the field period, and
said one color light source group is turned off at a time between a start time for writing display image in a subsequent field period at pixels along scanning electrode on a center line of a light source illumination range of said one color light source group, and reset time for resetting the liquid crystal into a black state in the field period at a pixel along the latest scanning electrode of pixels of the liquid crystal device in the light source illumination range of said one color light source group.

13. An apparatus according to claim 3, wherein one of the color light source groups is turned on in a field period at a time which is later than a start time for writing a display image in a preceding field period at a pixel along the earliest scanning electrode of pixels of the liquid crystal device in a light source illumination range of said one color light source group and is earlier than that in the field period, and
said one color light source group is turned off at a time between a start time for writing display image in a subsequent field period at pixels along scanning electrode on a center line of a light source illumination range of said one color light source group, and reset time for resetting the liquid crystal into a black state in the field period at a pixel along the latest scanning electrode of pixels of the liquid crystal device in the light source illumination range of said one color light source group.

14. An apparatus according to claim 12, wherein the light source illumination range of said one color light source group overlaps with a light source illumination range of another light source group, a luminance at an overlapping illumination range being controlled by adjusting the time where said one color light source group is turned on.

15. An apparatus according to claim 2, wherein one of the color light source groups is turned on in a field period at a time between a start time for writing a display image at a pixel along the earliest scanning electrode of pixels of the liquid crystal device in a light source illumination range of said one color light source group and a start time for writing a display image at pixels along scanning electrodes on a center line of the light source illumination range of said one color light source group, and
said one color light source group is turned off at a time between a start time for writing display image in a subsequent field period at pixels along scanning electrode on a center line of a light source illumination range of said one color light source group, and reset time for resetting the liquid crystal into a black state in the field period at a pixel along the latest scanning electrode of pixels of the liquid crystal device in the light source illumination range of said one color light source group.

16. An apparatus according to claim 3, wherein one of the color light source groups is turned on in a field period at a time which is later than a start time for writing a display image in a preceding field period at a pixel along the earliest scanning electrode of pixels of the liquid crystal device in a light source illumination range of said one color light source group and is earlier than that in the field period, and
said one color light source group is turned off at a time between a start time for writing display image in a subsequent field period at pixels along scanning electrode on a center line of a light source illumination range of said one color light source group, and reset time for resetting the liquid crystal into a black state in the field period at a pixel along the latest scanning electrode of pixels of the liquid crystal device in the light source illumination range of said one color light source group.

17. An apparatus according to claim 5, wherein one of the color light source groups is turned on in a field period at a time which is later than a start time for writing a display image in a preceding field period at a pixel along the earliest scanning electrode of pixels of the liquid crystal device in a light source illumination range of said one color light source group and is earlier than that in the field period, and
said one color light source group is turned off at a time between a start time for writing display image in a subsequent field period at pixels along scanning electrode on a center line of a light source illumination range of said one color light source group, and reset time for resetting the liquid crystal into a black state in the field period at a pixel along the latest scanning electrode of pixels of the liquid crystal device in the light source illumination range of said one color light source group.

18. An apparatus according to claim 15, wherein the light source illumination range of said one color light source group overlaps with a light source illumination range of another light source group, a luminance at an overlapping illumination range being controlled by adjusting the times where said one color light source group is turned on and turned off.

19. An apparatus according to claim 1, wherein the light source unit provides a luminance which is controlled by adjusting a voltage supplied to the plurality of color light source groups.

20. An apparatus according to claim 1, wherein the light source unit provides a luminance which is controlled by adjusting a current passing through the plurality of color light source groups.

21. An apparatus according to claim 1, wherein the light source unit provides a luminance which is controlled by adjusting a pulse period of a voltage supplied to or a current passing through the plurality of color light source groups.

22. An apparatus according to claim 21, wherein the pulse period is sufficiently shorter than a lighting period of the color light source groups.

23. An apparatus according to claim 3, wherein one of the color light source groups provides a light source illumination range which overlaps with at most two light source illumination ranges of other color light source groups.

24. An apparatus according to claim 1, wherein one of the color light source groups is turned on in a field period at a time between a start time for writing a display image at a pixel along the earliest scanning electrode of pixels of the liquid crystal device in a light source illumination range of said one color light source group and a start time for writing a display image at pixels along scanning electrodes on a center line of the light source illumination range of said one color light source group, and
said one color light source group is turned off at a prescribed time between a start time for writing display image in a subsequent field period at pixels along scanning electrode on a center line of a light source illumination range of said one color light source group, and reset time for resetting the liquid crystal into a black state in the field period at a pixel along the latest scanning electrode of pixels of the liquid crystal device in the light source illumination range of said one color light source group, said prescribed time being changed depending on a change in response characteristic of the liquid crystal device in an operation temperature range.

25. An apparatus according to claim 1, wherein the liquid crystal has an alignment characteristic such that the liquid crystal is aligned to provide an average molecular axis to be placed in a monostable alignment state under no voltage application, is tilted from the monostable alignment state in one direction when supplied with a voltage of a first polarity at a larger tilting angle which varies depending on magnitude of the supplied voltage, and is tilted from the monostable alignment state in the other direction when supplied with a voltage of a second polarity opposite to the first polarity at a smaller tilting angle which varies depending on magnitude of the supplied voltage.
